(19) United States
(12) Patent Application Publication
(10) Pub. No.: US 2016/0232632 A1
(43) Pub. Date: Aug. 11, 2016

(54) SYSTEM AND METHOD FOR PROCESSING FOR E-OFFICE ACTION COMMUNICATIONS

(71) Applicant: TIMOTHY JAMES SOUTHGATE, HALF MOON BAY, CA (US)

(72) Inventor: TIMOTHY JAMES SOUTHGATE, HALF MOON BAY, CA (US)

(21) Appl. No.: 14/615,844

(22) Filed: Feb. 6, 2015

(51) Int. Cl. G06Q 50/18; G06Q 10/06; G06Q 10/10; H04L 12/58

(52) U.S. Cl. CPC G06Q 50/184; H04L 51/08; G06Q 10/06316; G06Q 10/10

(57) ABSTRACT

Systems and methods are described for receiving an e-Office Action communication from the United States Patent and Trademark Office (“USPTO”), wherein the communication is associated with a USPTO customer number and a patent matter. The communication comprises a first USPTO defined code indicating that the USPTO has communicated a first action on the patent matter. Verifying that the customer number is associated with an account of an intellectual property docketing system. Verifying that the patent matter associated with the first action is also associated with the account. Generating a first docketing task associated with both the patent matter and the account, wherein the first docketing task provides a description of the first action. Displaying the first docketing task on a computing device of one or more users of the account.

### SUMMARY OF THE INVENTION

Systems and methods are described for processing e-Office Action communications from the USPTO. In a first method, a processor performs the following steps. The processor receives an e-Office Action communication from the USPTO, wherein the communication is associated with a USPTO customer number and a patent matter. The communication comprises a first USPTO defined code indicating that the USPTO has communicated a first action on the patent matter. The processor verifies that the customer number is associated with an account of an intellectual property docketing system. The processor further verifies that the patent matter associated with the first action is also associated with the account. Next, the processor generates a first docketing task associated with both the patent matter and the account, wherein the first docketing task provides a description of the first action. Lastly, the processor displays the first docketing task on a computing device of one or more users of the account.

### BACKGROUND OF THE INVENTION

Intellectual property docketing systems (hereinafter “docketing systems”) exist as a means of tracking prosecution, procurement, and maintenance of intellectual property, comprising, but not limited to, patent and trademark applications and issued patents and trademarks. Such docketing systems provide historical records of each patent and trademark application and issued patents and trademarks associated with a business organization such as a law firm or a corporation. Docketing systems require a user to manually enter historical records and docketing tasks associated with a patent or trademark application or issued patent and trademark. Manually entry is time consuming and prone to human error. As such, a system and method is described that improves on the process for inputting historical records and docketing tasks into a docketing system.

### BRIEF DESCRIPTION OF THE DRAWINGS

In the following description, for the purposes of explanation, numerous specific details are set forth in order to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with other implementations as well. By the same token, however, no single feature or features of any described implementation should be considered essential to the invention, as other implementations of the invention may omit such features.

FIG. 1 illustrates a flow process for receiving an e-Office Action communication and generating a docketing task.

FIG. 2 illustrates a flow process for generating one or more docketing tasks associated with a document code from an e-Office Action communication.

FIG. 3 illustrates an exemplary docketing system architecture for generating docketing tasks in response to receiving an e-Office Action communication from the USPTO.

### DETAILED DESCRIPTION OF THE INVENTION

Intellectual Property docketing systems (hereinafter “docketing systems”) provide a means for managing an intellectual property portfolio comprising of one or more of: U.S. patent applications and issued patents, U.S. trademark applications and issued trademarks, U.S. copyrights, Patent Cooperative Treaty (hereinafter “PCT”) patent applications, foreign patent applications and issued patents, and foreign trademark applications and issued trademarks. However, this list is not exclusive, as there is additional information and/or intellectual property assets that may be tracked with a docketing system. Some examples may include domain names, copyrights, contracts, and litigation to name a few. In one embodiment, a docketing system is a software application downloaded and installed onto a PC, MAC, or other computing device as a standalone application. In another embodiment, a docketing system is a cloud-based client/server service, accessible with an Internet browser from a computing device. Two features of a docketing system are 1) to maintain and track the bibliographic information of patent applications or issued patents; and 2) to maintain and track the prosecution history of patent applications and issued patents.

Throughout this specification the phrase “patent application” may refer to both U.S. and PCT based patent applications. Throughout this specification and the claims, the phrase “patent matter” may refer to both patent applications and issue patents. Throughout this specification, the phrase “prosecution history” refers to the official record of the examination of a patent application or issued patent which includes items listed in the USPTO's Private Pair information portal. Such items may include, but are not limited to: 1) informational items listed by the USPTO regarding a patent application or issued patent wherein such steps usually do not require a response from the applicant; 2) affirmative steps taken by the USPTO on a patent application or issued patent wherein such steps often elicit a response from the patent applicant; and 3) affirmative steps taken by a patent applicant which may be in response to a step taken by the USPTO or independent of any other steps. In one embodiment, “informational items listed by the USPTO” may include an acknowledgement that certain steps taken by the patent applicant have been received by the USPTO.

In one embodiment, the bibliographic information of a patent application or issued patent may comprise: the title of the application, the inventor(s), an attorney docketing number, a filing date, a publication date (if the application has published), an allowance date (if the application has been allowed, yet not yet issued), and an issue date. However, additional information may be tracked.

In order for a docketing system to maintain and track bibliographic information and prosecution history of a patent application or issued patent, the information must be input into the system. In one embodiment, the information may be entered into the system from a keyboard and/or mouse of a computing device. In another embodiment, the information may be input into the system by retrieving the information from a data file and uploading the information into the system. In other words, the data is not input into the system via a keyboard and/or mouse. One approach is through Extensible Mockup Language (“XML”) files. The U.S. Patent and Trademark Office (hereinafter “USPTO”) provides downloadable XML files from their website, via their Private Patent Application Information Retrieval portal (hereinafter “PAIR”). XML files downloadable from Private PAIR comprise the bibliographic information and prosecution history for both U.S. patent applications and issued patents as well as PCT patent applications. In one embodiment, an XML file could be imported into a docketing system as a means of populating the bibliographic information and prosecution history of patent applications and/or issued patents. Such an approach may eliminate the need for manual entry.

Any time the status or prosecution history of a patent application or issued patent changes, the Private PAIR provided XML file will be updated to include the information. By importing the new XML file into the docketing system, the change(s) to the patent application or issued patent may automatically update. While this approach can replace manual entry, it can still be time consuming to manually download an XML file each time a patent application or issued patent changes.

The USPTO also offers a service where updates to the prosecution history of a patent application or issued patent can be emailed to one or more persons associated with the patent application or issued patent. These emails are called e-Office Actions. The information contained in the email identifies the USPTO's customer number, one or more patent application numbers and/or issued patent numbers, attorney docketing number, one or more codes indicating the type of information added to the prosecution history and a date for each code. In one embodiment, a USPTO customer number is an alphanumeric string associated with a registered account with the USPTO. A customer number allows the customer to file, track, respond to, and pay fees for patent applications and issued patents through Private Pair. Once a customer number is established, patent applications and issued patents may be associated with the customer number. Here is an example of the substantive content of an e-Office Action.
Dear PAIR Customer:
The following USPTO patent application(s) associated with your Customer Number, 89483, have new outgoing correspondence. This correspondence is now available for viewing in Private PAIR. Application Document Mailroom Date Attorney Docket No. 17287529 NOA 01/02/2015 ABC123-US1

The last line of the e-Office Action indicates the application number [17287529], the document code indicating the type of correspondence communication from the USPTO [NOA], the date of the correspondence [01/02/2015], and the attorney docket number [ABC123-US1]. In this example, NOA stands for Notice of Allowance. Below is an excerpt from the USPTO's official Document Codes spreadsheet, which is made available to the public.

| Document Code | Document Description |
|---|---|
| NAPI | Defective/Not Acceptable Notice of Appeal |
| NFDR | Notice of Formal Drawings Required |
| NFEE | Notice of Additional Fee Due |
| NOA | Notice of Allowance and fees due (PTOL-85) |
| NRES | Letter Restarting Period for Response (i.e. |
| | Letter re: References) |
| NT.AE.A.NONC | PTO 2239AE - Notice of Non-Responsive Reply |
| | (Accelerated Exam) |
| NT.CR.APP.PA | Notice to File Corrected Application Papers |
| NT.INC.REPLY | Notice of Incomplete Reply |

Thus, a computing system could receive a code from the e-Office Action, query a database or the USPTO's Document Codes spreadsheet, and receive, as output, the description of the code. Once a description of the code is received, a docketing system may generate one or more docketing tasks based on the content of the e-Office Action.

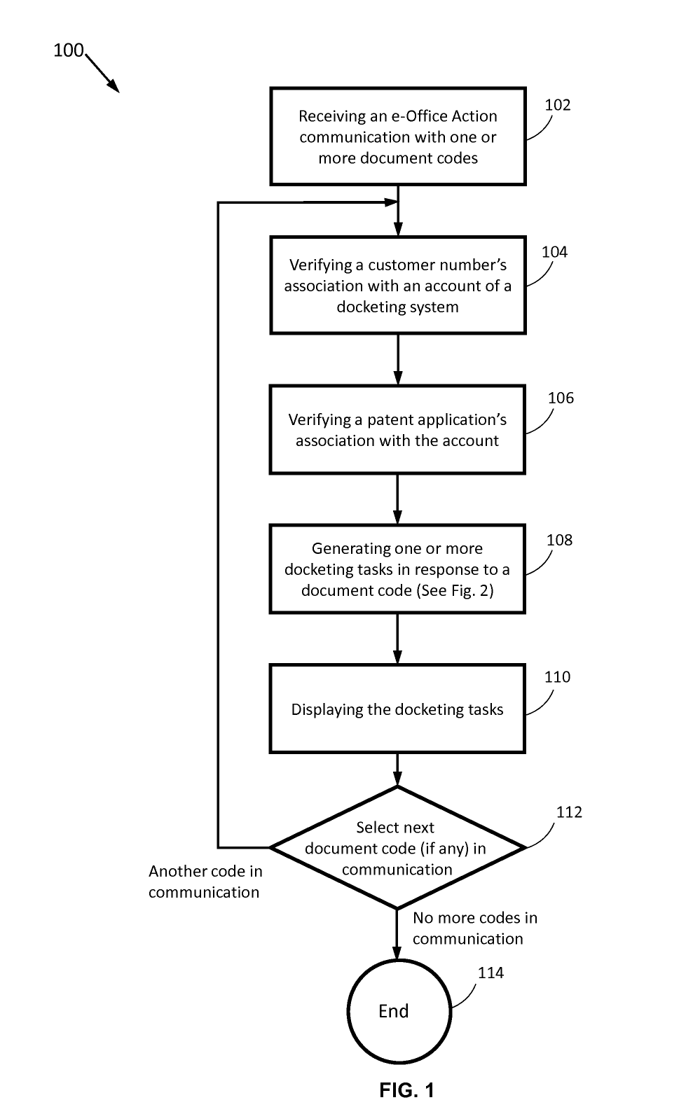

FIG. 1 Illustrates a flow process 100 for receiving an e-Office Action communication and generating a docketing task. In one embodiment, a docketing system is used to receive the e-Office Action and generate one or more docketing tasks. The docketing system may comprise computer-readable instructions stored on a memory and executed by a processor. In a receiving step 102, the docketing system receives an e-Office Action communication from the USPTO, wherein the communication comprises one or more document codes. In one embodiment, the communication is an email sent to an email address associated with the docketing system, however, other communication means may be used such as HTTP/HTTPS, FTP/SFTP, or via an entry in a database to name a few. In one embodiment, an e-Office Action communication may be received from other entities aside from the USPTO, such as an individual or third party information processors. For example, an e-Office Action communication may be forwarded to the docketing system from a third party email account. In one embodiment, the contents of the communication may contain information similar to that shown in Paragraph [0018] above. In one embodiment, the communication is associated with both a USPTO customer number and a patent application or issued patent. The communication further comprises at least one USPTO-defined code indicating that the USPTO has communicated a first action on the patent application associated with the code.

Throughout this specification, and the claims, the phrase “action on the patent application” refers to any items listed in the prosecution history of a patent application or an issued patent as found in Private Pair. A current list of all such actions are listed in two USPTO provided documents entitled, “Customer Number Outgoing Correspondence Search Document Codes” and “Image File Wrapper Document Codes.” Both documents are incorporated by reference in their entirety and attached to this application as appendix items A and B.

In a verification step 104, the the docketing system verifies that the custom number, listed in the e-Office Action communication, is associated with an account of a docketing system. More specifically, the docketing system comprises one or more accounts, wherein each account is associated with one or more USPTO customer numbers. Thus, a correlation between the customer number included in the e-Office Action and a customer number stored in the docketing system is used to determine which account the e-Office Action is related to.

Verification step 104 may further comprise a querying step wherein the docketing system queries a database of customer numbers associated with the docketing system. Verification step 104 may further comprise a receiving step wherein the docketing system receives a verification, from the customer number database, whether the customer number is associated with the docketing system. In one embodiment, if the customer number is not associated with the docketing system, flow process 100 ends.

In another verification step 106, the docketing system verifies that the patent application or issued patent, listed in the e-Office Action communication, is associated with the same docketing system account associated with the customer number. Verification step 106 may further comprise a querying step wherein the docketing system queries a database of patent applications and issued patents associated with the docketing system. Verification step 106 may further comprise a receiving step wherein the docketing system receives a verification, from the patent application database, whether the patent application or issued patent is associated with the customer number. In one embodiment, if the patent application is not associated with the customer number, flow process 100 ends. In another embodiment, if the patent application is not associated with the customer number, a user of the account is notified that the patent application is not associated with their customer number and/or not associated with their account.

In a generation step 108, the docketing system generates one or more docketing tasks providing a description of the first action. The one or more docketing tasks are associated with both the customer number and the patent application or issued patent listed in the e-Office Action. Generation step 108 may further comprise a querying step wherein the docketing system queries a database of USPTO defined codes and code descriptions. Generation step 108 may further comprise a receiving step wherein the docketing system receives a description of the USPTO defined code associated with the first action. Generation step 108 may further comprise a provision step wherein the docketing system provides and inserts the USPTO defined code description into the one or more docketing tasks.

In a display step 110, the docketing system displays the one or more docketing tasks on a visual display of a computing device. In one embodiment, the display may be shown on a mobile phone, a tablet, a laptop or an external display device such as a monitor or projector. In one embodiment, the computing device is communicatively coupled to the docketing system via a wired or wireless communication network such as a local area network (“LAN”), a wide area network (“WAN”), a cellular network, or the Internet. In another embodiment, a list of docketing tasks including the generated docketing tasks may be e-mailed to a user of the docketing system.

In a decision step 112, if the e-Office Action communication comprises subsequent document codes, the process flow returns to step 104 for further processing of the subsequent document codes. If there are no subsequent document codes, the process ends at step 114. In can be appreciated that decision step 112 could occur before displaying step 110, without deviating from the scope of the invention.

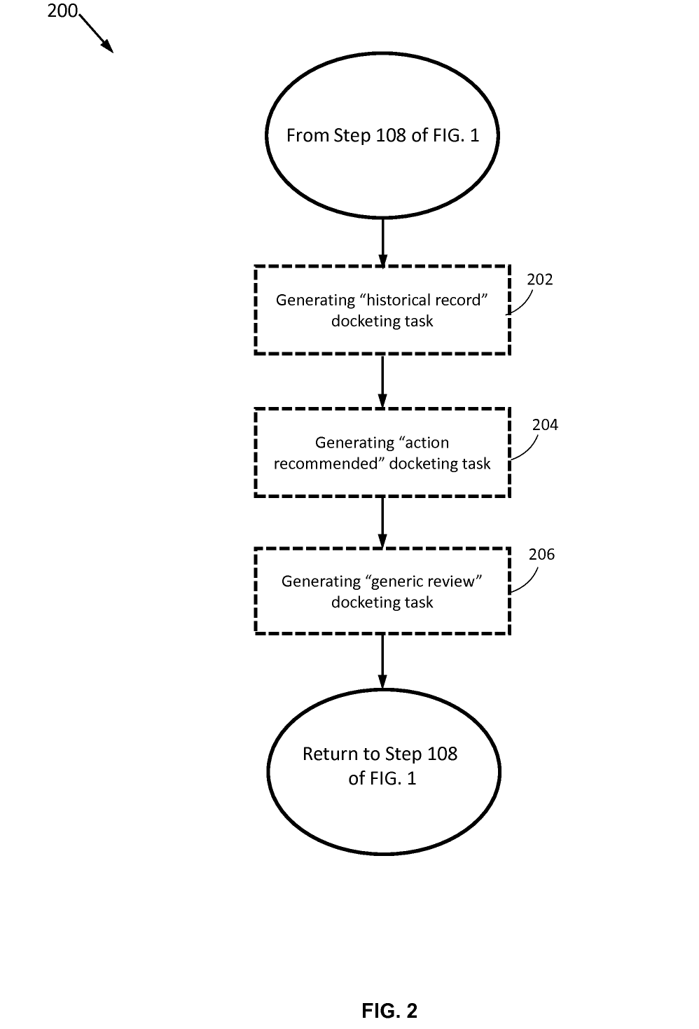

FIG. 2 illustrates a flow process 200 for generating one or more docketing tasks associated with a document code from an e-Office Action communication. In one embodiment, the steps of FIG. 2 are encompassed within step 108 from FIG. 1. In an optional generating step 202, a “historical record” docketing task may be generated based on a document code in the e-Office Action communication received in step 102 from FIG. 1 and further verified in steps 104 and 106. In one embodiment, the “historical record” task is a description of an action taken by the USPTO and displayed in the official prosecution history of the patent application or issued patent as shown in Private Pair.

In an optional generating step 204, an “action recommended” docketing task is generated. In one embodiment, the “action recommended” docketing task may indicate an action to be taken by a user of the account associated with the docketing item. In another embodiment, the “action required” docketing task may have been generated in response to the “historical record” docketing task. As an example, the “historical record” docketing task may indicate that the USPTO mailed a Non-Final Office Action for the patent application associated with the action. In response, the “action recommended” docketing task may be titled, “Respond to Non-Final Office Action”, which would be a suggested action to be taken by the user of the account associated with the docketing task.

In one embodiment, the docketing system comprises a database of docketing task types and USPTO generated codes. The database may be queried, with a first docketing task generated in step 202, wherein the database of docketing tasks will return one or more suggested docketing task types that are associated with the first docketing task. Generation step 204 may use one or more of the docketing task types when generating the “action recommended” docketing task. In one embodiment, the database of docketing task types may be queried with the USPTO generated code directly. In another embodiment, the database of docketing tasks may be queried with the description of the “historical record” docketing task.

In another embodiment, a docketing task, for example the “action recommended” docketing task, may include a number of attributes such as, but not limited to: an owner of the docketing task, a status, one or more dates, and a comment to name a few. A task owner may be different than the person with overall responsibility for a patent application or an issued patent. For example, an attorney may be responsible for the patent application, yet a paralegal may be the owner of one or more tasks associated with the patent application. A task's status may include options such as: open, closed, not needed, missed, and pending to name a few. The dates associated with a task may include a reference date, a due date and an extendable due date. In one example, a “Respond to Non-Final Office Action” may have a reference date of Jan. 1, 2014 (which may be the date the office action was mailed by the USPTO), a due date of Apr. 1, 2014 (3-months from the reference date), and an extendable due date of Jul. 1, 2014 (6 months from the reference date). A docketing task may also have one or more comments associated with it, such as instructions on how the task owner should proceed, what triggered the task to be created, etc.

In an optional generation step 206, a “generic review” docketing task is created. In one embodiment, the “generic review” docketing task may indicate a generic action to be taken by a user of the account associated with the docketing item. In another embodiment, the “generic review” docketing task may have been generated in response to the “historical record” docketing task. As an example, the “historical record” docketing task may indicate that the USPTO received a supplemental amendment for the patent application associated with the action. In response, the “generic review” docketing task may be titled, “Review USPTO Communication: Supplemental Amendment Received”, which would be a suggested action to be taken by the user of the account associated with the docketing task. In another embodiment, the “generic review” docketing task may be generated if the document code from the e-Office Action communication was not recognized. In another embodiment, the “generic review” docketing task may be generated if no docketing tasks were generated in optional generation steps 202 and 204.

Any of steps 202-206 are optional, as indicated by the dotted lines. For example, any of a “historical record”, “action recommended”, and “generic review” task may be generated without any other tasks being generated.

In another example, an intellectual property docketing system receives a single e-Office Action communication comprising three actions taken by the USPTO. A first action associated with a first patent application; a second action associated with the first patent application; and a third action associated with a first issued patent. The docketing system verifies that the patent application and the customer number associated with the first action is also associated with an account of the docketing system. In other words, the customer number associated with the first action must also be associated with an account of the docketing system. Additionally, the patent application associated with the first action must also be associated with a patent application associated with the same account tied to the customer number.

Once the associations are verified, the docketing system may generate a first docketing task providing information on the action taken by the USPTO. For example, the first docketing task may be a “historical record” task. Next, a second docketing task is generated in response to the content of the first docketing task, wherein the second docketing task recommends (i.e., action recommendation task) an action to be taken.

In this example, the e-Office Action communication comprises a second action, associated with the first patent application. Therefore a third docketing task associated with the second action and the first patent application is generated and a fourth docketing task is generated. The fourth docketing task may be generated in response to the third docketing task.

The e-Office Action communication includes a third action associated with a first issued patent and the same customer number. Therefore, a fifth docketing task, associated with the third action and the first issued patent, is generated. Further, a sixth docketing task is generated in response to the fifth docketing task.

In one embodiment, a single e-Office Action communication may comprise actions taken by patent applications or issued patents from different customer numbers. In other words, a first action may be associated with a first application of a first customer number. While a second action may be associated with a first application of a second customer number.

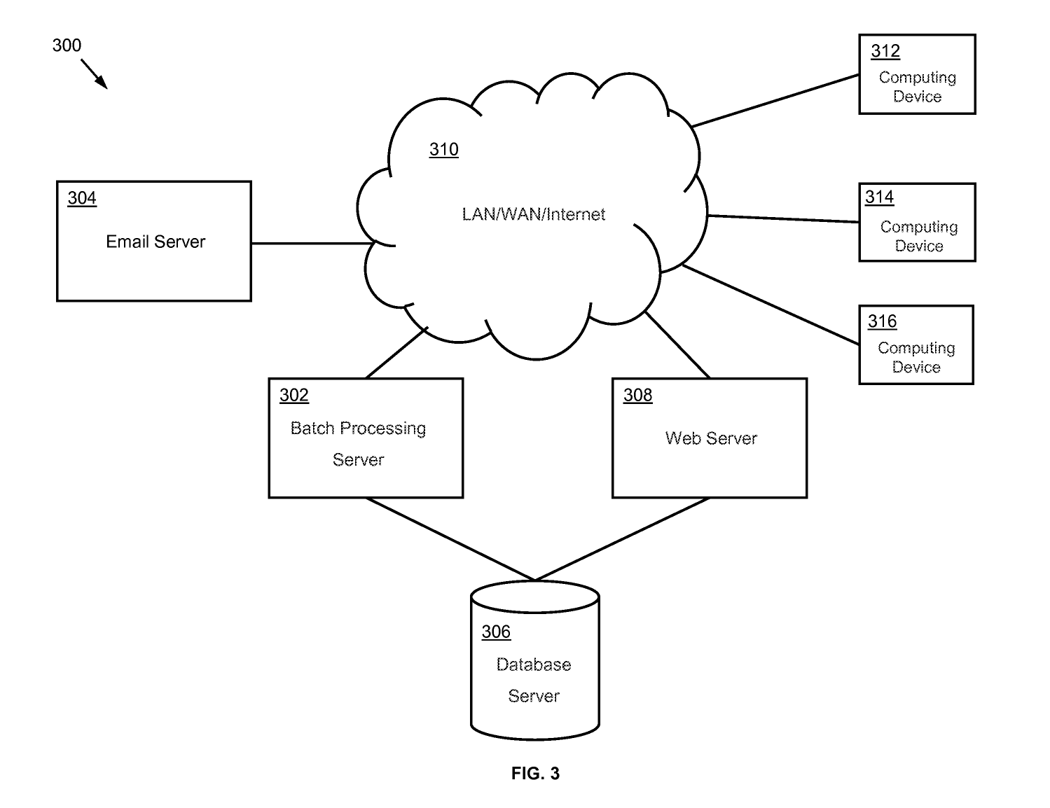

FIG. 3 illustrates an exemplary docketing system architecture 300 for generating docketing tasks in response to receiving an e-Office Action communication from the USPTO. Docketing system 300 comprises a Batch Processing Server 302, an Email Server 304, a Database Server 306, and a Web Server 308. The Batch Processing Server 302 is communicatively coupled to both the Email Server 304 and the Web Server 308 through a network such as LAN/WAN/Internet 310. The Web Server 308 is further communicatively coupled to the Email Server 304 and the Database Server 306 through the LAN/WAN/Internet 310. However, other communication means may be used without deviating from the scope of the invention. In one embodiment, any of the Servers 302, 304, 306, and 308 may comprise multiple physical servers. Additionally, one or more the Servers 302, 304, 306, and 308 may be contained within the same physical server.

In one embodiment, the Batch Processing Server 302 queries the Email Server 304 to determine if any e-Office Action communications have been received. Alternatively, an e-Office Action communication may be pushed to the Batch Processing Server 302 from the Email Server 304. If an e-Office Action communication has been received, the contents of the communication are transmitted to the Web Server 308 for processing. As described in FIG. 1, the Web Server 308 will query the Database Server 306 with a customer number and a patent application/issued patent number contained in the e-Office Action communication against accounts of the docketing system. If a match is found, the Database Server 306 is queried with a USPTO generated code associated with an action taken by the USPTO. The Database Server 306 will then generate a docketing task associated with the account and the patent application/issued patent matching the customer number. In one embodiment, the docketing task record added to a relational database with associations to an account record and a patent application/issued patent record. Additionally, the docketing task may have any of an owner, a status, a reference date, a due date, an extendable due date, and a comment.

The Web Server 308 queries the Database Server 306 to retrieve and serve information associated with the account and the docketing task to a display of one or more computing devices 312, 314, and 316. In one embodiment, device 312 is a display coupled to a computer, device 314 is a smart phone, and device 316 is a tablet. However, one skilled in the art can appreciate that different types of computing devices may be used.

In one embodiment, the Web Sever 308 is communicatively coupled to the computing device 312 via the LAN/WAN/Internet 310, wherein an Internet browser of the computing device 312 receives the docketing task from the Web Server 308 via an HTTP, HTTPS, FTP, or SFTP request. However, the Web Server 308 may serve the docketing task to the computing device 312 via an installed software application. Additionally, the Web Server 308 may serve the docketing task to the computing device as an email, via the Email Server 304. Further, the email may contain a docketing report comprising the docketing task and other docketing tasks meeting a pre-defined criteria. In another embodiment, the Web Server 308, via the Email Server 304, may send docketing reports to an email address associated with the account at pre-defined intervals and with pre-defined filtering criteria.

Unless specifically stated otherwise, as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a flash memory device, such as a compact flash card or USB flash drive.

Some exemplary embodiments described herein are described as software executed on at least one computer, though it is understood that embodiments can be configured in other ways and retain functionality. The embodiments can be implemented on known devices such as a server, a personal computer, a smart phone, a tablet device, a special purpose computer, a programmed microprocessor or microcontroller and peripheral integrated circuit element(s), and ASIC or other integrated circuit, a digital signal processor, a hard-wired electronic or logic circuit such as a discrete element circuit, or the like. In general, any device capable of implementing the processes described herein can be used to implement the systems and techniques according to this invention.

It is to be appreciated that the various components of the technology can be located at distant portions of a distributed network and/or the internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The terms determine, calculate and compute, and variations thereof, as used herein are used interchangeably and include any type of methodology, process, mathematical operation or technique.

The invention described and claimed herein is not to be limited in scope by the specific embodiments herein disclosed since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

What is claimed is:

1) A method comprising:
receiving, by a processor executing an application, an e-Office Action communication (“communication”) from the United States Patent and Trademark Office (“USPTO”), wherein the communication is associated with a USPTO customer number and a patent matter, and wherein the communication comprises a first USPTO defined code indicating that the USPTO has communicated a first action on the patent matter;
verifying, by the processor executing the application, that the customer number is associated with an account of an intellectual property docketing system;
verifying, by the processor executing the application, that the patent matter associated with the first action is also associated with the account;
generating, by the processor executing the application, a first docketing task associated with both the patent matter and the account, wherein the first docketing task provides a description of the first action; and
displaying, by the processor executing the application, the first docketing task on a computing device of one or more users of the account.

2) The method of claim 1, further comprising:
querying a database of customer numbers associated with the intellectual property docketing system;
receiving a verification that the customer number is associated with the account of the intellectual property docketing system;
querying a database of patent matters associated with the intellectual property docketing system;
receiving a verification that the patent matter is associated with the account;
querying a database of USPTO defined codes and code descriptions;
receiving a description of the USPTO defined code from the database; and
providing the description of the USPTO defined code to the first docketing task.

3) The method of claim 2, further comprising:
generating a second docketing task, in response to the first docketing task;
wherein the second docketing task suggests an action to be taken by the one or more users of the account; and
wherein each of the first and second docketing tasks have a list of attributes comprising: the patent matter, the description of the USPTO defined code, a task owner, a task status, and a reference date, wherein the first docketing task further includes an event date, and wherein the second docketing task further includes a respond by date.

4) The method of claim 3, further comprising:
wherein the communication comprises a second USPTO defined code indicating that the USPTO has taken a second action on the patent matter;
generating a third docketing task associated with both the patent matter and one or more users of the account, wherein the third docketing task provides a description of the second action taken by the USPTO;
generating a fourth docketing task, in response to the third docketing task; and
wherein the fourth docketing indicates an action to be taken by the one or more users of the account.

5) The method of claim 4, further comprising:
wherein the communication comprises a third USPTO defined code indicating that the USPTO has taken an action on a second patent matter;
generating a fifth docketing task associated with both the second patent matter and the one or more users of the account, wherein the fifth docketing task provides a description of the action taken by the USPTO with respect to the second patent matter;
generating a sixth docketing task, in response to the fifth docketing task; and
wherein the sixth docketing task indicates an action to be taken by the one or more users of the account.

6) The method of claim 3, wherein the reference date of the first docketing task is the date the first action was communicated by the USPTO, and wherein the respond by date of the second docketing task indicates the date that a response to the first action is due.

7) The method of claim 5, wherein the communication is further associated with a second USPTO customer number having at least one USPTO defined code indicating that the USPTO has communicated a fourth action on a third patent matter associated with the second USPTO customer number.

8) The method of claim 1, wherein the first docketing task is presented to the one or more users via email.

9) The method of claim 1, wherein the first docketing task is presented to the one or more users via a docketing report scheduled to run at a pre-defined time interval; and
wherein the intellectual property docketing system receives the communication via email.

10) The method of claim 3, wherein the step of generating a second docketing task, in response to the first docketing task further comprises:
querying a database of docketing task types having a list of USPTO generated codes and a list of suggested docketing task types associated with each code; and
receiving, from the database of docketing tasks types, one or more suggested docketing tasks associated with the first docketing task.

11) A system comprising: one or more processors and memory coupled to the one or more processors and configured for storing instructions, which, when executed by the one or more processors, cause the one or more processors to perform operations comprising:
receiving an e-Office Action communication (“communication”) from the United States Patent and Trademark Office (“USPTO”), wherein the communication is associated with a USPTO customer number and a patent matter, and wherein the communication comprises a first USPTO defined code indicating that the USPTO has communicated a first action on the patent matter;
verifying that the customer number is associated with an account of an intellectual property docketing system;
verifying that the patent matter associated with the first action is also associated with the account;
generating a first docketing task associated with both the patent matter and the account, wherein the first docketing task provides a description of the first action; and
displaying the first docketing task on a computing device of one or more users of the account.

12) The system of claim 11, further comprising:
querying a database with the customer number associated with the communication;
receiving a verification that the customer number from the communication is associated with an account of the intellectual property docketing system;
querying the database with the patent matter associated with the communication;
receiving a verification that the patent matter is associated with the account;
querying the database with the USPTO defined code associated with the communication;
receiving a description of the USPTO defined code from the database; and
providing the description of the USPTO defined code to the first docketing task.

13) The system of claim 11, further comprising:
querying a database of suggested USPTO action responses with the first action taken by the USPTO;
receiving a first and a second suggested docketing task type;
generating a second and a third docketing task, in response to the first docketing task; and
wherein the second and third docketing tasks suggest actions to be taken by the one or more users of the account.

14) The system of claim 13, further comprising;
wherein the communication comprises a second USPTO defined code indicating that the USPTO has taken a second action on the patent matter;
generating a fourth docketing task associated with both the patent matter and the one or more users of the account, wherein the fourth docketing task provides a description of the second action taken by the USPTO;
generating a fifth docketing task, in response to the fourth docketing task; and
wherein the fifth docketing indicates an action to be taken by the one or more users of the account.

15) The system of claim 14, further comprising:
wherein the communication comprises a third USPTO defined code indicating that the USPTO has taken an action on a second patent matter; and
generating a sixth docketing task associated with both the second patent matter and the one or more users of the account, wherein the sixth docketing task provides a description of the action taken by the USPTO with respect to the second patent matter;
generating a seventh docketing task, in response to the sixth docketing task; and
wherein the seventh docketing task indicates an action to be taken by the one or more users of the account.

16) The system of claim 15, further comprising:
wherein the communication is further associated with a second USPTO customer number having at least one USPTO defined code indicating that the USPTO has communicated a fourth action on a third patent matter associated with the second USPTO customer number;
querying the database with the second customer number associated with the fourth action;
receiving a verification that the second customer number is associated with an account of the intellectual property docketing system; and
generating an eighth docketing task associated with both the second customer number and the third patent matter, wherein the eighth docketing task provides a description of the fourth action taken by the USPTO with respect to the third patent matter.

17) The system of claim 11, further comprising:
wherein the communication is received by an email forwarded by the one or more users of the account; and
wherein the first and second docketing tasks are provided to the one or more users as a docketing report attached to an email.

18) The system of claim 11, further comprising:
wherein the first action taken by the USPTO includes a date that the first action occurred; and
wherein a due date of the second docketing task is based on the date of the first action.

19) The system of claim 11, further comprising:
wherein the contents of the communication is received as a database record inserted into a communication database; and
wherein the communication database is periodically queried for new communications from the USPTO.

20) A computer program product that includes instructions stored in a non-transitory medium, the instructions configured to cause a processor to perform operations comprising:
receiving an e-Office Action communication (“communication”) from the United States Patent and Trademark Office (“USPTO”), wherein the communication is associated with a USPTO customer number and a patent matter, and wherein the communication comprises a first USPTO defined code indicating that the USPTO has communicated a first action on the patent matter;
querying a database with the customer number associated with the communication;
receiving a verification that the customer number from the communication is associated with an account of the intellectual property docketing system;
querying the database with the patent matter associated with the communication;
receiving a verification that the patent matter is associated with the account;
querying the database with the USPTO defined code associated with the communication;
receiving a description of the USPTO defined code from the database;
generating a first docketing task associated with both the patent matter and the account, wherein the first docketing task provides a description of the first action based on the description of the USPTO defined code from the database; and
querying the database with the first action taken by the USPTO to receive a first and a second suggested docketing task type;
generating a second and a third docketing task, wherein the second and third docketing tasks suggest actions to be taken by the one or more users of the account in response to the first docketing task; and
displaying the first, second, and third docketing task on a computing device of the one or more users of the account.
